(19) United States
(12) Patent Application Publication
(10) Pub. No.: US 2005/0033672 A1
(43) Pub. Date: Feb. 10, 2005

(54) System, method, and computer program product for managing financial risk when issuing tender options

(75) Inventors: Jean-Michel Lasry, Paris (FR); Pierre-Louis Lions, Paris (FR); Marc Romano, Fontenay-sous-Bois (FR); Remy Croisille, Nogent-sur-Marne (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: CREDIT-AGRICOLE INDOSUEZ, Courbevoie (FR)

(21) Appl. No.: 10/623,514

(22) Filed: Jul. 22, 2003

(51) Int. Cl. G06F 17/60

(52) U.S. Cl. 705/35

(57) ABSTRACT

A method, system, and computer program product for mitigating exposure risk when issuing tender options by way of a price grid that includes adjustments to the premium paid by a client to a financial institution based on actual numbers of contracts won by the client. The method includes grouping financial risks; determining a risk hedging parameter corresponding to the financial risks; defining an average risk reference scenario; determining a probability of occurrence for commercial hazards that correspond to the financial risks; establishing a reference pricing grid expressing a risk hedging price as a function of the actual outcomes of the commercial hazards; and adjusting the risk hedging price in the pricing grid based on an actual occurrence of at least one of the commercial hazards.

### BACKGROUND OF THE INVENTION

1. Field of the Invention

This invention relates to a system, method, and computer program product for mitigating exposure risk when issuing tender options by way of a price grid that includes adjustments to the premium paid by a client to a financial institution based on actual numbers of contracts won by the client.

2. Description of the Related Art

A company making tenders for contracts on an international market is exposed to a foreign exchange risk between the moment the company decides to enter the tender and the moment the result is announced. FIG. 1 is a flow chart for making tenders for contracts exposed to foreign exchange risk. There are three phases: submitting, responding, and carrying out. The submitting phase is when a company seeks bid-hedge protection for an upcoming contract(s) by submitting an application for protection. The responding phase is when the company's bid(s) are being tendered and evaluated. The carrying out phase is when the results of the company's bid(s) are being announced (accepted or rejected) and when the bid-hedge protection payouts are made. For instance, a European company making a tender for a contract drawn up in U.S. dollars (USD) will have to face, in case it wins the tender, cash inflows in USD and cash outflows in Euros (EUR). Therefore, it will be exposed to financial risks due to unfavorable changes in USD/EUR exchange rate when bringing the project to completion.

One characteristic of this risk is that the risk materializes only if the company wins the tender. However, the flow structure is known when submitting the tender at the latest.

To secure the operational profitability, the company looks to incorporate the price of the foreign exchange risk into the bid price by using hedging mechanisms (either directly from the financial markets or from specific financial institutions.)

There are classical solutions that the company may use to hedge its financial position. For example, conditional to the bid success, the company may have a classical foreign exchange position that may be hedged against through foreign exchange rate forward contracts or through options written on the foreign exchange rate. Indeed, because the cash flows structure is known from the beginning, the only source of risk comes from the exchange rate value the day the cash flow occurs. Consequently, the company may adopt several hedging strategies.

One conventional hedging strategy is a priori hedging through forward contracts. The company buys forward contracts during the submitting phase. Doing so, it hedges itself for all the tenders it may win. But it will have a speculative position on foreign exchange rate through the forward contracts it bought to hedge tenders that will not have been won.

Another conventional hedging strategy is a posteriori hedging through forward contracts. The company buys, once the tender result is announced, and in case it wins, a sufficient amount of forward contracts to hedge the flows that are now sure to occur. This hedging locks in the profit or loss due to foreign exchange rates movements during the responding phase. This profit or loss will affect the company's margin accordingly.

Another conventional hedging strategy is hedging based on options written on the whole nominal amount. This hedging strategy consists in buying options covering all the potential flows. The company may exercise or not these options (in particular, it may exercise them if it will have won the tender associated to the hedged flow). But this strategy implies an over-hedging too expensive to be effective.

Another conventional hedging strategy is hedging based on exotic options written on the whole nominal amount. This strategy is a development of the preceding one, by using options with more complex structures, in order to reduce the over-hedging. But problems may arise due to possible discrepancies between the strategy attached to these options and the real exposure resulting from the tenders.

A common feature of these conventional approaches is the handling of purely financial hedging products which does not encompass the commercial risk resulting from the tender outcome. Therefore, with these approaches, the company will have to choose either a) to assume a part of the non-financial risk and thus put at risk a part of its operational profitability or b) to over-hedge its financial risks to be protected in all cases and thus penalize its profitability by buying such a protection.

The above-identified shortfalls associated with the above-described classical strategies have encouraged financial intermediaries to introduce so-called “tender options” or “bid-hedge products,” which are foreign exchange forward contracts conditioned to the success of a tender bid. Pricing and hedging methods for these financial products use stochastic control theory.

Conventional tender options and bid-hedge products are predicated on the company describing all flows of capital that a successful tender may induce. Once these flows are identified, the financial institution offers the conventional tender option or bid-hedge product with a premium broken down in two parts
a commitment premium p_{c} which is paid when the option is bought (i.e. during the submitting phase); and
an outcome premium pₒ which is paid if and only if the company wins the tender (i.e. when the result is announced).

More often, a company is offered with a set of combinations (p_{c}, pₒ) from which the company chooses one combination of premiums associated with obtaining the option. Thus, the company is hedged against foreign exchange risk. FIG. 2 is a flow chart for conventional tender option or bid-hedge product generation. During the submitting phase, the company seeking protection provides the insurer with cash-flow characteristics which allow the insurer to develop a pricing grid. The company chooses a price/feature combination and commits to a premium. The insurer then engages in internal hedging to protect its position. After the bids are either accepted or rejected in the responding phase, the company pays the agreed premium in the carrying out phase and the insurer delivers its forward contracts.

While the company is hedged against foreign exchange risk, the financial intermediary remains exposed to an “insurance-like” risk (i.e., risk that the bid will or will not succeed) which the financial intermediary itself will try to hedge through mutualization (i.e., by selling several such products, both ways; e.g. USD against EUR and EUR against USD).

In practice, the financial institution that offers a bid-hedge product, conventionally does so on a contract-by-contract basis. Thus, a satisfactory mutualization is very hard to obtain for many reasons to include vagaries and volatility of the market and the client's profile. Indeed, in a one-by-one approach, the seller of the option is exposed to a moral hazard since the buyer will only buy the option for the riskiest tenders. There is also the risk for the financial institution to be exposed only to large tenders for which extreme events are harder to offset through diversification. Another concern about size is the fixed costs (e.g. legal fees, commercial expenses) needed to implement a single contract and that penalize tenders with small overall notional. To overcome these difficulties, the present inventors have invented a new system and method for hedging tender-associated risks of a company.

The present inventors recognized that the risk to which the financial institution is exposed is much lower if a large number of bid-hedge products are combined into a single contract with a single client. As more bid-hedge product are combined into a “portfolio” of bid-hedge products for a company placing a variety of bids, the financial institution is able to then use the bidding company's estimates for success in a binding manner that prevents risks associated with accidental or purposeful misrepresentation of the bidding company's chances. If the information provided from the bidding party proves to be inaccurate, in the statistical concept, the bidding party is charged an enhanced premium. The possibility of an enhanced premium incentivizes greater accuracy and/or shifts the penalty from inaccurate estimates from the financial institution to the bidding company. In addition, by binding together a series of tenders, it becomes possible to include smaller tenders, without incurring the financial burden of multiple fixed costs.

Moreover, the present inventors recognized that a new method of pricing and a new system implementing this method should be established to numerically compute the price of a “portfolio” of tender options agreed upon with a single client. Indeed, the classical method would require establishing a pricing grid with a number of prices exponentially increasing as the number of tenders. This makes the practical implementation of the new method impossible with the current state of the art. By developing a new pricing approach, a pricing grid with a number of prices equal to the number of tenders is sufficient.

### SUMMARY OF THE INVENTION

One objective of the present invention is to address the above-identified deficiencies associated with conventional bid-hedge product.

Another objective of the present invention is to reduce the risk faced by a financial institution by managing multiple bid-hedge events within a single contract so as to create a population of statistical data from which to calculate premium adjustment. Related to the availability of the greater population of statistical data, is the use of feed-forward premium adjustment, based on a statistical analysis of actual bid results from predicted bid results that are provided by the party requesting the bid-hedge product. The premium for both a single bid-hedge event, as well as for future bit-events that are part of a common bid-hedge portfolio may be adjusted based on the quality of information provided by bid-hedge requesting party. By shifting the penalty (in the form of an Ex post premium increase) of inaccurate estimates from the financial institution to the bid-hedge requesting party, the bid-hedge requesting party has the motivation of providing quality information to the bid-hedge provider, thereby minimizing the risk to bid-hedge provider.

Another objective of the present invention is to hedge a company against market risks by a contract with a financial institution. In the contract the company commits, for a defined period of time, to hedge itself through the financial institution against a predetermined number of tenders, where the company also describes a priori the characteristics of the risks that will be induced by acceptance of these tenders. Then, an individual contract is attached to each and every tender. From the information provided by the company, a “reference scenario” is developed by the financial institution.

In addition to describing a priori the characteristics of the risks that will be induced by acceptance of these tenders, the company also declares to the financial institution the number of tenders it expects to win. Alternatively, the company assigns a probability of winning to each tender. With these parameters, the financial institution sets up a “reference premium” corresponding to the premium of the foreign exchange guarantee for the reference scenario. This reference premium is conditioned on the success of the company's individual bids.

Another objective of the invention is to provide for a mechanism for individual contracts to be modified during the life of the overall contract according to rules detailed in the overall contract. For example, a rule may be that when one of the tenders included in the overall contract is successful, the company receives from the financial institution a guarantee that is based on the reference premium (adjusted by corrective factors defined by the overall contract and taking into account differences between the reference scenario and the actual tender.)

Another objective of the present invention is to provide a mechanism for a company to appropriately compensate the financial institution when an overall option contract comes to maturity. In this mechanism, the company pays to the financial institution the premium corresponding to the guarantees attached to the tenders the company has won. If the actual number of won tenders differs from the number identified in the contract, the company pays an additional compensation to the financial institution an amount defined by contract, where the amount is a function of the difference between the number of winning tenders predicted and the actual number of winning tenders.

Therefore, the process includes three components: an overall contract closing process; a process for each tender included in the overall contract; and a process for premium payment and compensation, if needed, at the expiration of the contract.

Also, payment clauses may be modified so that the financial institution does not have to face a counterparty risk. For instance, the financial institution may use rules to share out the premium payment over the overall contract lifetime with an adjustment in fine (this adjustment is needed since the exact premium is known expost, once the results of all the tenders included in the overall contract are known). At the completion of the three phases, a standard contract has been established.

The present invention's tender options implementation includes two steps: first, conditionally computing the price and hedge of each option to the number of tenders won; and, second, an ex post adjustment rules calculation. Algorithms for these two steps can been implemented in a processor-based system programmed in any computational language (e.g., C++) and the results can be visualized by any common spreadsheet tool (e.g., Microsoft Excel or other format that conveniently presents numeric data).

The first step includes the computation of a reference premium using reference scenario parameters defined by contract and which are a function of information provided by the company. For first generation tender options, both a commitment premium and an outcome premium are calculated. This computation of the reference premium is the result of the numerical solving of an equation resulting from the indifference price using an exponential utility function. Once the commitment premium and the outcome premium are known, an option pay-off is calculated. The reference hedging strategy can then be implemented two ways: a) by performing a linear regression on a set of well-chosen put options; and b) by surreplicating the option payoff (since it is a convex function).

The second step includes a calculation of the utility function by a Taylor expansion of order 2. This leads to an analytical formula for the indifference price conditionally to the number of successes, which brings back to a conditional variance calculation. This method also permits adjustment rules to be defined for the individual contracts included in the overall contract. These adjustments also have the effect of an internal hedging strategy. Risk management is conducted using Monte-Carlo simulations, for quantile evaluation as well as for stress scenario assessments.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a flow chart for making tenders for contracts exposed to foreign exchange risk;

FIG. 2 is a flow chart for conventional tender option or bid-hedge product generation;

FIG. 3a is a flow chart of an overall contract closing process of the present invention;

FIG. 3b is another flow chart of an overall contract closing process of the present invention;

FIG. 4 is a flow chart of a process for including a specific tender in the overall contract of the present invention;

FIG. 5 is a flow chart of an optional premium payment and compensation process in the overall contract closing process of the present invention; and

FIG. 6 is a block diagram of a computer used in one embodiment of the present invention.

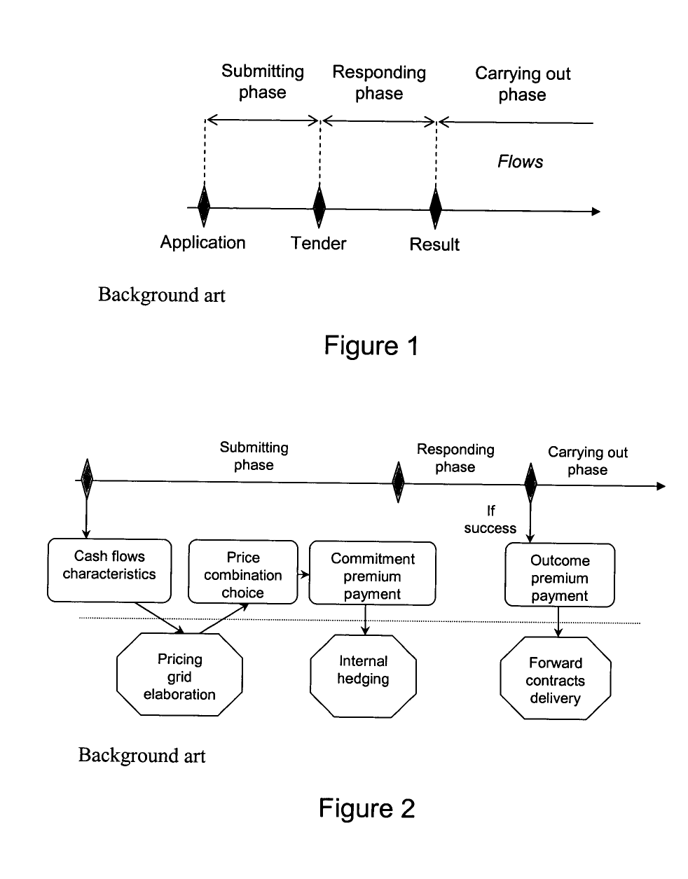

### DETAILED DESCRIPTION OF THE PREFERRED EMBODIMENTS

Pricing and hedging methods for tender options rely upon stochastic control theory. Therefore, it is appropriate to review some useful results from control theory. For a more thorough discussion of control theory, and its application to pricing and tender offers, Applicant hereby incorporates by reference in their entirety, the following references:
Regarding stochastic control theory:
   Optimal Control of Diffusion Processes and Hamilton-Jacobi-Bellman Equations, ‘Part I: The Dynamic Programming Principle and Applications’, by P.-L. Lions, paper published in Comm. Partial Differential Equations, vol. 8, pp. 1101-1174, 1983.
   Deterministic and Stochastic Optimal Control, by W. H. Fleming and R. W. Rishel, ‘Applications of Mathematics—Stochastic Modelling and Applied Probability’ series, Springer-Verlag, 1996 (ISBN: 0387901558).
Regarding mathematical finance:
   Martingale Methods in Financial Modelling, by M. Musiela and M. Rutkowski, ‘Applications of Mathematics—Stochastic Modelling and Applied Probability’ series, Springer-Verlag, 1997 (ISBN: 354061477X).
Regarding application of stochastic control theory to finance:
   A Stochastic Control Approach to the Pricing of Options, by E. N. Barron and R. Jensen, paper published in Math. Operations Research, vol. 15, pp. 49-79, 1990.
   European Option Pricing with Transaction Costs, by M. H. A. Davis, V. P. Panas and T. Zariphopoulou, paper published in SIAM Journal Control Optim., vol.31, pp. 470-493, 1993.
   Hedging in Incomplete Markets with HARA Utility, by D. Duffie, W. Fleming, M. Soner and T. Zariphopoulou, paper published in Dynamics and Control, vol. 21, pp. 753-782, 1997.

In a deterministic setting, a generic optimization problem can be written:

$$\{ \begin{matrix} \frac{ⅆ x}{ⅆ s} = f ( x , s , u ) ; x ( t ) = x ; s ∈ [ t , T ] \\ J ( u ) = {\int }_{t}^{T} g ( x ( s ) , s , u ( s ) ) ⅆ s + h ( x ( T ) )\end{matrix}$$

where the first part is constituted by the evolution equation, followed by limit conditions, u being the control function. J is the cost functional which needs to be minimized (note that h is the final cost). The value function is defined by

$$V ( x , t ) = {Inf}_{u ( s ) {\vert}_{[ t , T ]}} \{ J ( u ) \}$$

which satisfies the limit condition:
V(x,T)=h(x)

The Bellman dynamic programming principle states that, on a optimal path (\overline{x}(s),\overline{u}(s))|_{[t,T]} the optimal control from starting point (\overline{x}(t*),t*) with t<t*<T is precisely \overline{u}(s)|_{[t*,T]}. It implies that one can use a recursive method to find an optimal control, built upon the starting point and with an additive criterion on the cost functional.

In a discrete time framework, one can write the evolution equation and the cost functional as follows:

$$\{ \begin{matrix} {x}_{l + 1} = F ( {x}_{l} , l , {u}_{l} ) ; {x}_{k} = x ; l ∈ [ k , K ] \\ J ( u ) = {\sum }_{l = k}^{K - 1} G ( {x}_{l} , l , {u}_{l} ) + h ( {x}_{K} )\end{matrix}$$

where the minimization program is:

$$V ( x , k ) = {Inf}_{{u}_{k} , … , {u}_{K - 1}} \{ {\sum }_{l = k}^{K - 1} G ( {x}_{l} , l , {u}_{l} ) + h ( {x}_{K} ) \} .$$

Using the Bellman principle in the discrete time framework, one can get:

$$V ( x , k ) = \begin{matrix}{Inf}_{{u}_{k} , … , {u}_{K - 1}} \{ G ( {x}_{k} , k , {u}_{k} ) + \\ {Inf}_{{u}_{k} , … , {u}_{K - 1}} \{ {\sum }_{l = k + 1}^{K - 1} G ( {x}_{l} , l , {u}_{l} ) + h ( {x}_{K} ) \} \} ,\end{matrix}$$

which is equivalent to:

$$\{ \begin{matrix} V ( x , k ) = {Inf}_{{u}_{k}} \{ G ( x , k , {u}_{k} ) + V ( F ( x , k , {u}_{k} ) , k + 1 ) \} \\ V ( x , K ) = h ( x )\end{matrix}$$

In a continuous time framework, the dynamic programming principle gives:

$$∀ {t}^{′} ∈ ] t , T [ \{ \begin{matrix} V ( x , t ) = {Inf}_{u} \{ \int g ( x ( s ) , s , u ( s ) ) ⅆ s + V ( x ( {t}^{′} ) , {t}^{′} ) \} \\ V ( x , T ) = h ( x )\end{matrix}$$

With small time increments, we can rewrite the first part of the above expression as:

$$V ( x , t ) = {Inf}_{u} \{ g ( x , t , u ) d t + V ( x ( t + d t ) , t + d t ) \} .$$

Because
x(t+dt)=x+dt f(x,t,u)
we can expand the function V at point (x(t+dt),t+dt):

$$\begin{matrix}V ( x ( t + d t ) , t + d t ) = V ( x + d t f ( x , t , u ) , t + d t ) \\ = V ( x , t ) + d t 〈 {∇}_{x} V ( x , t ) \vert f ( x , t , u ) 〉 + d t \frac{\partial V}{\partial t} ( x , t )\end{matrix}$$

Furthermore, the Bellman principle teaches:
Infᵤ{V(x,t)}=V(x,t)

Using [0036]-[0037] in [0035], we get the following expression:

$$\begin{matrix}V ( x , t ) = \begin{matrix}{Inf}_{u} \{ g ( x , t , u ) d t + V ( x , t ) + \\ d t 〈 {∇}_{x} V ( x , t ) \vert f ( x , t , u ) 〉 + d t \frac{\partial V}{\partial t} ( x , t ) \}\end{matrix} \\ = V ( x , t ) + d t \times \frac{\partial V}{\partial t} ( x , t ) + \\ d t \times {Inf}_{u} \{ g ( x , t , u ) + 〈 {∇}_{x} V ( x , t ) \vert f ( x , t , u ) 〉 \}\end{matrix}$$

Simplifying the above expression leads to the result known as the Hamilton-Jacobi-Bellman theorem, which states that the value function V is the solution of the following partial differential equation (PDE):

$$\{ \begin{matrix} \frac{\partial V}{\partial t} ( x , t ) + {Inf}_{u} \{ g ( x , t , u ) + 〈 {∇}_{x} V ( x , t ) \vert f ( x , t , u ) 〉 \} = 0 \\ V ( x , T ) = h ( x )\end{matrix}$$

The Merton problem consists in finding, for a given maturity of investment T and an initial wealth x, the optimal asset allocation with respect to risk/return under a self-financing hypothesis. This problem can be viewed as a stochastic control problem with the control process being the asset allocation, the controlled process being the portfolio value, and the value function being the utility of the portfolio value at maturity.

Considering a world with two assets:
a risk-free bond:
   dBₜ=rBₜ dt
a risky asset with the following dynamic under real probability:
   dSₜ=μ Sₜ dt+σ Sₜ dWₜ

If α is an amount of risky asset held by the investor (i.e. the control process), the self-financing portfolio value Xₜ at time t (i.e. the controlled process) follows:
dXₜ=rXₜ dt+(μ−r)α dt+σα dWₜ.
The value function that maximizes the expected utility of the final wealth:

$$v ( x , t ) = {Sup}_{α} I E [ U ( {X}_{T} ) \vert {X}_{t} = x ]$$

must satisfy the following limit condition:
v(x,T)=Sup_{α} IE[U(X_{T})|X_{T}=x]=U(x)

Again turning to the Bellman principle, we know that the value function is such that:

$$∀ h > 0 v ( x , t ) = {Sup}_{α} \{ I E [ v ( {X}_{t + h} , t + h ) \vert {X}_{t} = x ] \} .$$

For small time increments h (i.e., Ito's formula):

$$v ( {X}_{t + h} , t + h ) = \begin{matrix}v ( {X}_{t} , t ) + h {v}_{t} + ( {X}_{t + h} - {X}_{t} ) {v}_{x} + \\ \frac{1}{2} {( {X}_{t + h} - {X}_{t} )}^{2} {v}_{xx} + o ( h + {\vert {X}_{t + h} - {X}_{t} \vert}^{2} )\end{matrix}$$

Taking the expectation of that expression, it is possible to arrive at:

$$I E [ v ( {X}_{t + h} , t + h ) \vert {X}_{t} = x ] = \begin{matrix}v ( x , t ) + h {v}_{t} + ( r x + \\ ( μ - r ) α ) h {v}_{x} + \frac{1}{2} {α}^{2} {σ}^{2} h {v}_{xx} + o ( h )\end{matrix}$$

Recognizing that

$$v ( x , t ) = {Sup}_{α} v ( x , t )$$

and taking the limit as h→0 one can finally get:

$${v}_{t} + {Sup}_{α} \{ ( r x + ( μ - r ) α ) {v}_{x} + \frac{1}{2} {α}^{2} {σ}^{2} {v}_{xx} \} = 0$$

The above expression, together with the limit condition, leads to the HJB equation for the Merton problem, which states that the value function as defined in [0042] is a solution of the following PDE:

$$\{ \begin{matrix} \frac{\partial v}{\partial t} + {Sup}_{α} \{ ( r x + ( μ - r ) α ) \frac{\partial v}{\partial x} + \frac{1}{2} {α}^{2} {σ}^{2} \frac{{\partial }^{2} v}{\partial {x}^{2}} \} = 0 \\ v ( x , T ) = U ( x )\end{matrix}$$

The utility function is concave, so we can divide by vₓₓ<0. Therefore, the optimal control can be defined as:

$${\hat{α}}_{Merton} = - \frac{( μ - r ) {v}_{x}}{{σ}^{2} {v}_{xx}}$$

and the value function is the solution of the following PDE:

$$\{ \begin{matrix} {v}_{t} + r x {v}_{x} - \frac{{( μ - r )}^{2}}{2 {σ}^{2}} \frac{{v}_{x}^{2}}{{v}_{xx}} = 0 \\ v ( x , T ) = U ( x )\end{matrix}$$

The Constant Absolute Risk Aversion (CARA) utility function is defined by:
U(y)=−e^{-λy}

Thus, the indifference price of two independent pay-offs y₁ and y₂ is the sum of the two separate indifference prices:
U(p_{y}_{₁}_{+y}_{₂})=IE[U(y₁+y₂)]=−IE[U(y₁)]IE[U(y₂)]=−U(p_{y}_{₁})U(p_{y}_{₂})=U(p_{y}_{₁}+p_{y}_{₂})

With such a function, one can solve explicitly the previously identified HJB equation for the Merton problem as stated in [0048]:

$$v ( x , t ) = - exp ( - λ \times {ⅇ}^{r ( T - t )} ) exp ( - \frac{{( μ - r )}^{2}}{2 {σ}^{2}} ( T - t ) )$$

Considering the above result, one may note:
In a world with only the risk-free asset:
   v(x,t)=−exp(−λxe^{r(T-t)})=U(xe^{r(T-t)})
In a world with the risky asset, the investor can use an investment strategy to get an average gain of

$$\frac{{( μ - r )}^{2}}{2 {λσ}^{2}} ( T - t ) ,$$
compared with the risk-free world, since in that case

$$v ( x , t ) = U ( x {ⅇ}^{r ( T - t )} + \frac{{( μ - r )}^{2}}{2 {λσ}^{2}} ( T - t ) ) .$$
If the risk premium \overline{λ} of the risky asset is defined by μ=r+\overline{λ}σ² the optimal command is

$$\hat{α} = \frac{\overline{λ} {ⅇ}^{- r ( T - t )}}{λ}$$
that is the ratio between the discounted risk premium and the risk aversion.

With these considerations, it is possible to price a derivative on a tradable asset using HJB optimization problem with a contingent terminal cash-flow.

First, consider an asset paying at maturity T the cash-flow φ(S_{T}). For an investor having this derivative in his/her portfolio, the optimal command will change. Indeed, the value function is now:

$$u ( S , x , t ) = {Sup}_{α} I E [ U ( {X}_{T} - φ ( {S}_{T} ) ) \vert {S}_{t} = S , {X}_{t} = x ]$$

where the portfolio value process still verifies
dXₜ=rXₜ dt+(μ−r)α dt+σα dWₜ.

The value function now depends on the spot value of the risky asset (because of the final pay-off). In other words, there are two variables, namely Sₜ and Xₜ, and one command, α. Consequently, the HJB equation for this problem is:

$$\{ \begin{matrix}\frac{\partial u}{\partial t} + {Sup}_{α} \{ ( rx + ( μ - r ) α ) \frac{\partial u}{\partial x} + μ S \frac{\partial u}{\partial S} + \frac{1}{2} {α}^{2} {σ}^{2} \frac{{\partial }^{2} u}{\partial {x}^{2}} + \frac{1}{2} {S}^{2} {σ}^{2} \frac{{\partial }^{2} u}{\partial {S}^{2}} + α S {σ}^{2} \frac{{\partial }^{2} u}{\partial S \partial x} \} = 0. \\ u ( S , x , T ) = U ( x - φ ( S ) )\end{matrix}$$

The optimal command can be inferred easily as:

$$\hat{α} = - \frac{( μ - r ) {u}_{x} + S {σ}^{2} {u}_{Sx}}{{σ}^{2} {u}_{xx}} .$$

which can be injected into HJB equation to produce:

$$\{ \begin{matrix}{u}_{t} + {rxu}_{x} + μ {Su}_{S} - \frac{{( ( μ - r ) {u}_{x} + S {σ}^{2} {u}_{Sx} )}^{2}}{2 {σ}^{2} {u}_{xx}} + \frac{1}{2} {S}^{2} {σ}^{2} {u}_{SS} = 0 \\ u ( S , x , T ) = U ( x - φ ( S ) )\end{matrix}$$

By definition, the indifference price of the contingent claim paying φ(S_{T}) at time T is the value p such that the investor is indifferent, with respect to the expected utility, between receiving p at t and paying the cash-flow at T, and doing nothing. Obviously, the price p should at least depend on the time t and the spot value S: p=p(S, t). In mathematical terms, p(S, t) is such that:
u(S,x+p(S,t),t)=v(x,t),
where v is the optimal solution of the Merton problem as exhibited above, corresponding to “doing nothing” (i.e. the investor just optimizes its initial wealth x).

If one assumes that the option price is independent from the investor's wealth x, this is equivalent to:
u(S,x,t)=v(x−p(S,t),t)

Using this equality in the PDE satisfied by u, one can get the following PDE (taken at point (S, x−p(S, t),t)):

$${v}_{t} - {v}_{x} {p}_{t} + {rxv}_{x} - μ {Sv}_{x} {p}_{S} - \\ \frac{{( ( μ - r ) {v}_{x} - S {σ}^{2} {v}_{xx} {p}_{S} )}^{2}}{2 {σ}^{2} {v}_{xx}} + \frac{1}{2} {S}^{2} {σ}^{2} ( {v}_{xx} {p}_{S}^{2} - {v}_{x} {p}_{SS} ) = 0 ,$$

which is equivalent to the following PDE at point (S, x, t):

$${v}_{t} - {v}_{x} {p}_{t} + r ( x + p ) {v}_{x} - μ {Sv}_{x} {p}_{S} - \\ \frac{{( ( μ - r ) {v}_{x} - S {σ}^{2} {v}_{xx} {p}_{S} )}^{2}}{2 {σ}^{2} {v}_{xx}} + \frac{1}{2} {S}^{2} {σ}^{2} ( {v}_{xx} {p}_{S}^{2} - {v}_{x} {p}_{SS} ) = 0.$$

Because v satisfies the PDE stated in [0048], the above PDE simplifies to:

$${v}_{x} ( {p}_{t} - rp + rS {p}_{s} + \frac{1}{2} {S}^{2} {σ}^{2} {p}_{SS} ) = 0.$$

which can be simplified dividing by vₓ>0 since the function v is concave.

The pricing process also satisfies the limit condition p(S,T)=φ(S).

Combining [0060] and [0061], we see that the contingent claim pricing PDE can be expressed as:

$$\{ \begin{matrix}\frac{\partial p}{\partial t} - rp + rS \frac{\partial p}{\partial S} + \frac{1}{2} {S}^{2} {σ}^{2} \frac{{\partial }^{2} p}{\partial {S}^{2}} = 0 \\ p ( S , T ) = φ ( S )\end{matrix}$$

However, this may be recognized as the Black-Scholes PDE that derives from risk-neutral valuation, which means that the two pricing methods are coherent one with another.

Also, using the indifference relation between u and v, one can write the optimal control \hat{α} as:

$$\hat{α} = - \frac{( μ - r ) {v}_{x} - S {σ}^{2} {v}_{xx} {p}_{s}}{{σ}^{2} {v}_{xx}} = {\hat{α}}_{Merton} + S {p}_{S} .$$

The second term is exactly the standard Black-Scholes delta hedging and again is evidence that the contingent claim pricing PDE is equivalent to the Black-Scholes PDE.

Next, one can consider a contingent claim paying, at time T, the payoff Φ(S_{T}, Z) where S is a tradable asset as before, and Z a non-tradable lottery whose result is known just after the value of S_{T} is known.

To solve this problem, one can suppose that the investor's utility function is of CARA type:
U(y)=−e^{-λy}.

In this framework, the value function maximizes the expected utility of the final wealth minus the option payoff:

$$w ( S , x , t ) = {Sup}_{α} IE [ U ( {X}_{T} - Φ ( {S}_{T} , Z ) ) \vert {S}_{t} = S , {X}_{t} = x ] .$$

Note that the optimal control cannot depend on Z since it is not known until maturity. Consequently, as in the previous section, one can have two variables Xₜ and Sₜ, and one command α.

As one cannot have a control on Z, the optimal control is the same as before, except that it is necessary to change the terminal condition. Instead of a deterministic payoff, one can now have a random payoff depending on the outcome of the lottery Z. The terminal condition should then be expressed as the expected utility of this outcome. With such considerations, the pricing process of the contingent claim is defined by the following PDE and limit condition:

$$\{ \begin{matrix}\frac{\partial p}{\partial t} - rp + rS \frac{\partial p}{\partial S} + \frac{1}{2} {S}^{2} {σ}^{2} \frac{{\partial }^{2} p}{\partial {S}^{2}} = 0 \\ p ( S , T ) = \frac{1}{λ} ln ( IE [ exp ( λ Φ ( {S}_{T} , Z ) ) \vert {S}_{T} = S ] )\end{matrix}$$

To prove this theorem one may first note that by definition, p(S,T) should be the indifference price for entering the lottery at time T, knowing that S_{T}=S, which can be written:
w(S,x+p(S,T),T)=v(x,T),
or equivalently:
w(S,x,T)=v(x−p(S,T),T)=U(x−p(S,T))
because of the terminal condition v(x,T)=U(x)

From before, one can also know that:

$$\begin{matrix}w ( S , x , T ) = {Sup}_{α} IE [ U ( {X}_{T} - Φ ( {S}_{T} , Z ) ) \vert {S}_{T} = S , {X}_{T} = x ] \\ = IE [ U ( x - Φ ( {S}_{T} , Z ) ) \vert {S}_{T} = S ] .\end{matrix}$$

Thus, x being deterministic:
U(−p(S,T))=IE[U(−Φ(S_{T},Z))|S_{T}=S]
which leads to the desired result:

$$\{ \begin{matrix}\frac{\partial p}{\partial t} - rp + rS \frac{\partial p}{\partial S} + \frac{1}{2} {S}^{2} {σ}^{2} \frac{{\partial }^{2} p}{\partial {S}^{2}} = 0 \\ p ( S , T ) = \frac{1}{λ} ln ( IE [ exp ( λ Φ ( {S}_{T} , Z ) ) \vert {S}_{T} = S ] )\end{matrix}$$

Now one may consider a financial institution selling the contingent claim with payoff Φ(S,Z). One can know that its indifference price, i.e. the price at which it is willing to sell the product, is equal to p(Sₜ, t) at time t.

If the financial institution sells the product to a client, the financial institution can buy (or delta-hedge directly) the exotic option with payoff equal to φ(S_{T})=p(S_{T}, T) delivered at T. Today's price of this exotic option is equal to p(Sₜ, t), that is the price of the claim depending on the lottery. So the financial institution might sell the contingent claim and buy at the same time the exotic option for the same price. The resulting cash-flow at time t is 0.

If the financial institution has sold two different claims Φ₁ and Φ₂ depending on two independent lotteries Z₁ and Z₂, then the payoff of the exotic option the financial institution will have to buy is:

$$\begin{matrix}p ( S , T ) = \frac{1}{λ} ln ( IE [ exp ( λ ( {Φ}_{1} ( {S}_{T} , {Z}_{1} ) + {Φ}_{2} ( {S}_{T} , {Z}_{2} ) ) ) \vert {S}_{T} = S ] ) \\ = \begin{matrix}\frac{1}{λ} ln ( IE [ exp ( {λΦ}_{1} ( {S}_{T} , {Z}_{1} ) ) \vert {S}_{T} = \\ S ] IE [ exp ( {λΦ}_{2} ( {S}_{T} , {Z}_{2} ) ) \vert {S}_{T} = S ] )\end{matrix} \\ = \begin{matrix}\frac{1}{λ} ln ( IE [ exp ( {λΦ}_{1} ( {S}_{T} , {Z}_{1} ) ) \vert {S}_{T} = S ] ) + \\ \frac{1}{λ} ln ( IE [ exp ( λ {Φ}_{2} ( {S}_{T} , {Z}_{2} ) ) \vert {S}_{T} = S ] )\end{matrix} \\ = {p}_{1} ( S , T ) + {p}_{2} ( S , T )\end{matrix}$$

Because the Black-Scholes PDE is linear, one can see that the hedge for the two contingent claims depending on the independent lotteries is the sum of the hedges taken separately. This means that, if the financial institution can sell several contingent claims on independent and identically distributed lotteries, the financial institution can reduce its variance. In other words, the residual risk, (i.e., the risk attached to the lotteries) can be covered through mutualization.

Thus far, it has been shown that the hedge was such that the contingent claim seller can be indifferent to the lottery outcome. Thus the hedge is highly dependent on the lottery probability law. And yet, in many cases, the option buyer has more information on this law than the seller. There is truly a moral hazard here. For instance, in the case of the tender options where the lottery is the outcome of a tender, the buyer is a bidder and has far more information on its chances of success than the financial institution which cannot access all the information about the tender, at least for practical reasons.

One solution to this problem, as recognized by the present invention, is to package the hedge product in such a way that the total payoff for the financial institution makes it indifferent to the outcome of the lottery, i.e. its expected utility, conditionally to the outcome of the lottery is equal to 0. Therefore, one can now have two conditions of conditional indifference (with respect to the value of the tradable asset S and to the lottery outcome Z). So, if ψ represents the payoff for the financial institution, one must have:
IE[U(Ψ(S_{T},Z))|S_{T}]=U(0)
IE[U(Ψ(S_{T},Z))|Z]=U(0)

Note that previously, the exotic option payoff φ(S_{T})=p(S_{T},T) was chosen so that the financial institution was indifferent conditionally to the value of the underlying tradable financial asset S. Indeed, in this case, the total payoff was:

$$\begin{matrix}Ψ ( {S}_{T} , Z ) = - Φ ( {S}_{T} , Z ) + φ ( {S}_{T} ) \\ = - Φ ( {S}_{T} , Z ) + \frac{1}{λ} ln ( IE [ {ⅇ}^{λΦ ( {S}_{T} , Z )} \vert {S}_{T} ] ) ,\end{matrix}$$

and the first condition was respected:

$$\begin{matrix}IE [ U ( Ψ ( {S}_{T} , Z ) ) \vert {S}_{T} ] = IE [ U ( - Φ ( {S}_{T} , Z ) + \frac{1}{λ} ln ( IE [ {ⅇ}^{λ Φ ( {S}_{T} , Z )} \vert {S}_{T} ] ) ) \vert {S}_{T} ] \\ = - IE [ \frac{{ⅇ}^{λ Φ ( {S}_{T} , Z )}}{IE [ {ⅇ}^{λ Φ ( {S}_{T} , Z )} \vert {S}_{T} ]} \vert {S}_{T} ] \\ = - 1 = U ( 0 )\end{matrix}$$

But the second condition cannot be satisfied with such forms of payoffs Φ because it does not depend explicitly on the lottery outcome Z. To comply with the second indifference condition, Φ must be dependent on Z. One way to do that is to build a two-step pricing scheme where, at time t, the client pays the commitment (or initial) premium πᵢ. Then, at time T, once the lottery result is known, the client pays a conclusion premium π_{c},(Z) whose value is determined by the lottery outcome.

With such pricing, the total payoff at time T for the financial institution is:
Ψ(S_{T},Z)=−Φ(S_{T},Z)+φ(S_{T})+π_{c}(Z).

In order to satisfy the first indifference condition, it is straightforward that the exotic option payoff must be slightly changed to:

$$φ ( {S}_{T} ) = \frac{1}{λ} ln ( IE [ {ⅇ}^{λ ( Φ ( {S}_{T} , Z ) - {π}_{c} ( z ) )} \vert {S}_{T} ] ) .$$

At time 0, the client will pay πᵢ to the financial institution which is the price of the option with payoff above. This price will depend on the conclusion premium chosen so that:
IE[U(−Φ(S_{T},Z)+φ(S_{T})+π_{c}(Z))|Z]=U(0).

The advantage of this two-step pricing method is that it enables the financial institution to make its client reveal the “true” probability of Z (i.e. the client's best estimate of the lottery outcome). Indeed, the financial institution can propose different couples of prices (πᵢ, π_{c},(Z)) so that a rational client will choose the optimal couple with respect to their own estimate, and the financial institution will have access to this estimate.

To sum up, these are the different steps in order to sell the contingent claim depending on the lottery Z:
Determine payoff Φ(S_{T}, Z);
Parameterize the probability law of the lottery outcome Z;
For each value of this parameter, determine the conclusion premium π_{c}(Z) to be indifferent conditionally to the lottery outcome;
For each conclusion premium determined above, determine the associated commitment premium πᵢ, i.e. today's price of the exotic option whose payoff is determined by conditional indifference with respect to the financial asset value;
Make the client choose among the different price couples (πᵢ, π_{c}, (Z));
Buy (or delta-hedge) the exotic option accordingly to the client's choice.

Now consider the case of tender options whose payoff at maturity is given by:
Φ(S_{T},Z)=Z S_{T}
where Zε{0,1} is the result of the tender and S is a traded financial asset.

These two random variables are assumed to be independent. Note that S can be the value of an exotic option written on a tradable asset maturing at time T. Also, due to delta-hedging S may be considered, from a theoretical point of view, a traded financial asset.

Denote by p the probability of success (i.e. Z=1) and look for a conclusion premium of the form: π_{c} (Z)=π_{c} Z (which means that the client will pay the fixed amount π_{c}, if and only if he/she wins the tender.) With such hypotheses, using results from above, the option payoff must of the form:

$$φ ( s ) = \frac{1}{λ} ln ( p {ⅇ}^{λ ( s - {π}_{c} )} + ( 1 - p ) )$$

The indifference condition with respect to Z is satisfied if and only if the two following equations are satisfied:
IE[e^{λ(S}^{_{T}}^{-π}^{_{c}}^{-φ(S}^{_{T}}⁾⁾]=1
IE[e^{-λφ(S}^{_{T}}⁾]=1

But one knows φ, so the two equations become:

$$IE [ \frac{{ⅇ}^{λ ( {S}_{T} , - {π}_{c} )}}{p {ⅇ}^{λ ( {S}_{T} - {π}_{c} )} + ( 1 - p )} ] = 1$$

$$IE [ \frac{1}{p {ⅇ}^{λ ( {S}_{T} - {π}_{c} )} + ( 1 - p )} ] = 1$$

Noting that

$$\frac{x}{px + ( 1 - p )} = \frac{1}{p} ( 1 - ( 1 - p ) \frac{1}{px + ( 1 - p )} )$$

one can see that the two conditions are equivalent.

Therefore, the conclusion premium π_{c}, must be chosen so that:

$$IE [ \frac{1}{p {ⅇ}^{λ ( {S}_{T} - {π}_{c} )} + ( 1 - p )} ] = 1$$

Given the type of payoff for the exotic option, one can approximate it using put options. More precisely, one can use some out of the money options, chosen through a linear regression on values at a sufficient number of points x₁, . . . , X_{M}. In mathematical terms, for a given set of strikes K₁, . . . , K_{L}, one will choose the weights w₁, . . . , W_{L} of the corresponding put options in order to minimize C defined by:

$$( \begin{matrix}φ ( {x}_{1} ) \\ ⋮ \\ φ ( {x}_{M} )\end{matrix} ) = ( \begin{matrix}{( {K}_{1} - {x}_{1} )}_{+} & ⋯ & {( {K}_{L} - {x}_{1} )}_{+} \\ ⋮ & & ⋮ \\ {( {K}_{1} - {x}_{M} )}_{+} & ⋯ & {( {K}_{L} - {x}_{M} )}_{+}\end{matrix} ) \times ( \begin{matrix}{w}_{1} \\ ⋮ \\ {w}_{L}\end{matrix} ) + ɛ$$

Compared to buying directly the option with payoff φ, the present approach has the advantage of allowing the financial institution to avoid large margins or hedging risks.

The first step is to compute the conclusion premium, which is given by the equation given above. This equation is of the form ƒ(θ)=1, where θ=e−^{λπ}_{c} and ƒ is a decreasing, convex function. Provided that one can compute ƒ, it can be solved by dichotomy.

The function ƒ is defined by:

$$f ( θ ) = IE [ \frac{1}{θ p {ⅇ}^{λ {S}_{T}} + ( 1 - p )} ] .$$

This integral is computed using the Simpson method, after a change of variable such the new integration interval is [0,1].

Once one has the conclusion premium, one can either compute numerically the optimal hedge or approximate it using put options as described above. One can then have the price couples (πᵢ, π_{c}).

In one embodiment, Monte-Carlo simulations are run to evaluate the profit and loss (P&L) distribution for risk management purposes. In other embodiments, other estimation techniques may be used to evaluate the P&L distribution.

As mentioned earlier, the seller of a tender option must cover the residual risk attached to the lotteries through mutualization. But, in practical, good mutualization of risks is hard to achieve. For that reason, the present scheme includes the selling of protections for several tenders to a unique client. In that case, the mutualization is achieved throughout the different tenders.

Applying the theory sketched above to this scheme, the client is required to announce a probability of success for each one of the M tenders included in the general contract. In the conventional art, the bank would have to design a pricing grid with 2^{M} parameters, which is obviously impractical. In the present invention, the idea is not to be conditionally indifferent to the result of each tender, but to be indifferent to the number of tenders won.

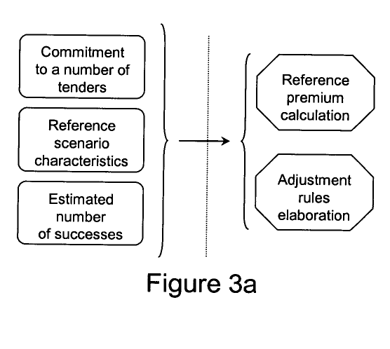

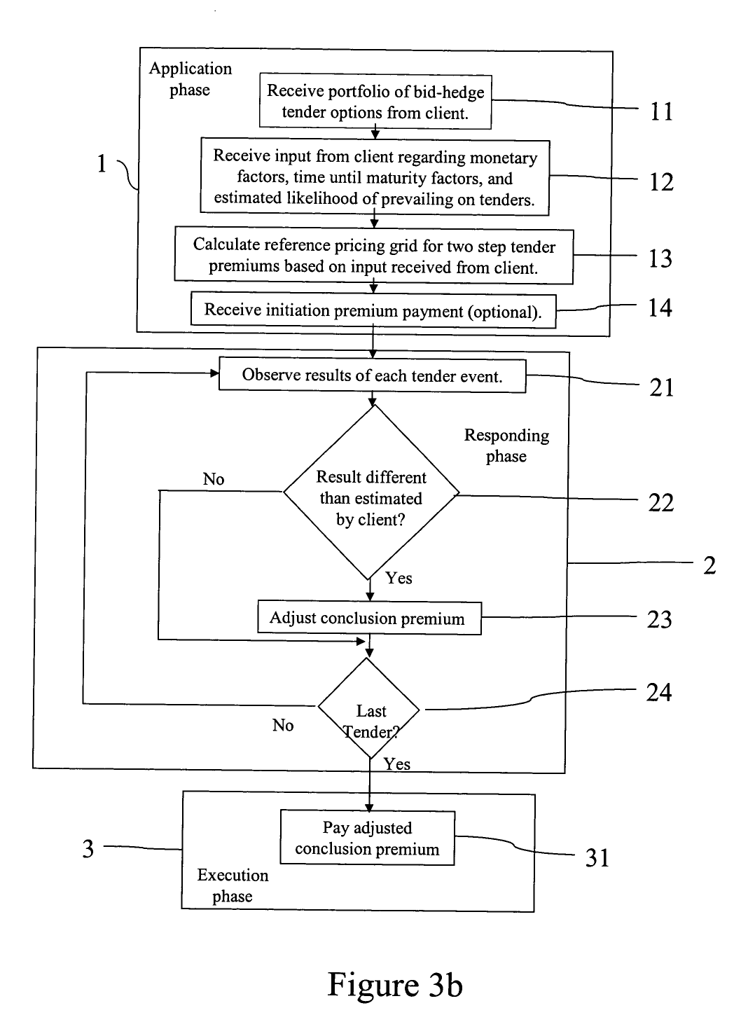

As shown in FIG. 3a, the process is the following:
The client commits to a number of tender options;
A reference scenario, built as an average of all the tenders, is elaborated (see below);
A pricing grid, depending of the number tenders won, is built;
The client announces the number of tenders that it is expecting to win;
At the end of the tenders series, the client pays an ex-post adjustment according to the number of tenders actually won.

As shown in FIG. 3b, the present invention comprises three phases: an application phase 1, a responding phase 2, and an execution phase 3.

The application phase 1 includes step 11 of receiving a portfolio of bid-hedge contracts from a client. This is followed by step 12 of receiving input from the client regarding monetary factors, time until maturity information, and estimated likelihood of prevailing on tenders. The monetary factors include bid price, bid currency, assumed exchange ratio, etc. This is followed by step 13 of calculating a reference pricing grid for the portfolio of tender premiums based on input received from client in step 12. The pricing grid includes a total premium comprising individual premiums for each tender as well as a premium adjustment parameter that accounts for differences between actual tender results from the client's predicted tender results. Upon agreeing to terms, the contract for the portfolio is signed. Optionally, a preliminary premium is paid by the client to the financial institution in step 13. The preliminary premium may be all or part of the total, unadjusted premium.

The responding phase 2 includes step 21 of observing the results of each tender followed by a decision in step 22 of whether the observed result was different from the predicted result. If the observed result is different, an adjustment to the overall premium is calculated in step 23. If the observed result is not different, an adjustment to the overall premium is calculated in step 23 and the process repeats until the results of the last tender is observed in step 24.

The execution phase 3 includes a final step 31 of paying an adjusted final premium. The final premium may be a totaled adjusted premium or an adjustment to a previously paid premium.

The pricing grid of the third step is the grid corresponding to the price of a “classical” tender option (i.e. as described in the preceding section), for the reference scenario, and a probability of success equal to the number of successes announced by the client divided by the total number of tenders M.

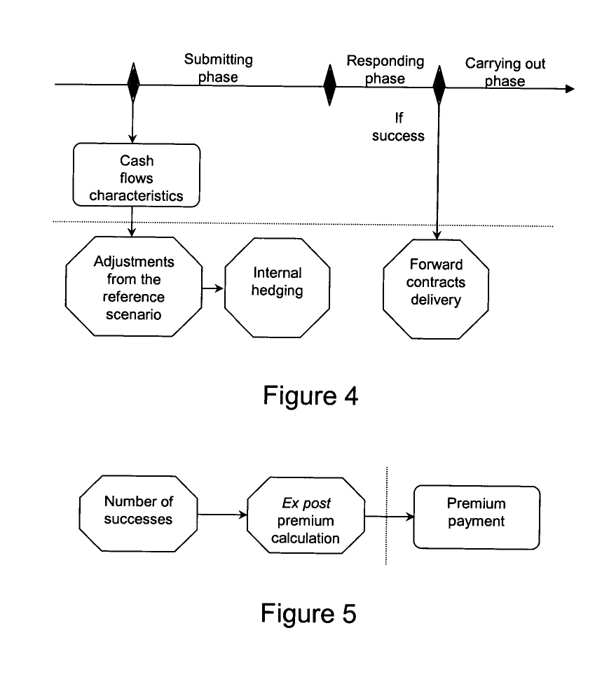

As shown in FIG. 4, for each tender, the process is as follows:
Define the real characteristics of the option and compute the pricing adjustments accordingly (see below);
Observe the outcome of the given tender;
Deliver, if necessary, the forward contracts.

To show more details, consider a set of tenders indexed by j=1, . . . , M. To each one of those, a forward exchange contract is attached. This contract is defined by:
tⱼ: the starting date, i.e. the date at which the forward rates are fixed and the option starts;
Tⱼ: the maturity date, at which the tender outcome can be observed and the forwards are delivered;
a schedule T_{j,1}, . . . , T_{j,nj} and a series of flows N^{d}_{j,1}, . . . , N^{d}_{j,n}_{ⱼ} in domestic currency and N^{f}_{j,1}, . . . , N^{f}_{j,n}_{ⱼ} in foreign currency which are exchanged at times defined by the schedule.

Note that the notional amounts are related through the forward exchange rates defined at time tⱼ, i.e.:
N^{d}_{j,k}=F(tⱼ,T_{j,k})N^{f}_{j,k}.

For this individual contract, the notional amounts in domestic and foreign currencies are respectively defined by:

$${N}_{j}^{d} = {\sum }_{k = 1}^{{n}_{j}} {N}_{j , k}^{d} \frac{{B}^{d} ( {t}_{j} , {T}_{j , k} )}{{B}^{d} ( {t}_{j} , {T}_{j} )} and {N}_{j}^{f} = {\sum }_{k = 1}^{{n}_{j}} {N}_{j , k}^{f} \frac{{B}^{f} ( {t}_{j} , {T}_{j , k} )}{{B}^{f} ( {t}_{j} , {T}_{j} )} .$$

where B^{d} and B^{f} stand for the prices of domestic and foreign zero-coupon bonds.

If σⱼ is the at-the-money (ATM) forward implied volatility for the forward exchange rate, quoted at time tⱼ for maturity Tⱼ, the size of this individual contract is defined by:
Σⱼ=(N^{d}ⱼ)²σⱼ²(Tⱼ−tⱼ.)

As for an individual contract, the reference scenario is defined through:
notional amounts (N^{d} and N^{f}) in domestic and foreign currency, respectively;
a time-to-maturity D;
a volatility a corresponding to the ATM forward implied volatility for exchange rate with maturity D.

The client provides estimates pa of success of the reference scenario. The size of the reference scenario and the total size of the tenders guarantee is:
Σ_{ref}=(N^{d})²σ²D and Σ=M Σ_{ref}.
The client also provides the total time-to-maturity Dₜₒₜ of the product.

As already mentioned, once the reference scenario is defined for M tenders, the central price of the pricing grid is computed using the method detailed in paragraphs [0087]-[0099] with a probability of success equal to p_{α} and other parameters equal to those of the reference scenario.

As shown in FIG. 5, the number of successes is used in an Expost calculation of a premium adjustment calculation which then leads to the final, adjusted premium payment. Therefore, should the number of successes of the tenders be equal to p_{α}M and the different tenders have the same characteristics as the reference scenario, the client would pay exactly M times the price of the tender option for one tender (divided in commitment and conclusion premia).

With the scheme described in the present invention, the client is penalized if the real outcomes of the totality of tenders differs from the estimate. This penalization is computed in such a way that the financial institution remains conditionally indifferent to the payoff with respect to the number of successes. In other words, the financial institution will charge the client for any difference between the expected utility of the payoff conditionally to the announced number of successes and the expected utility conditionally to the actual number of successes.

One can approximate this difference by using a Taylor expansion of order 2 for the utility function. Under such hypothesis, the computation is one of conditional variance which can be solved with closed-form formulas.

Assuming that the number of successes is k and skipping intermediary calculus, one can get to a closed-form formula of the expected utility conditionally to this number of successes k:

$$\begin{matrix}Λ = IE [ {Payoff}^{ 2} \vert {\sum }_{j = 1}^{M} {Z}_{j} = k ] \\ = \begin{matrix}{( {N}^{d} )}^{2} ( {ⅇ}^{{σ}^{2} D} - 1 ) ( {k}^{2} ( 1 - {p}_{a} ) {ρ}_{0} + \\ {( M - k )}^{2} {p}_{a}^{2} {ρ}_{1} - 2 k ( M - k ) {p}_{a} ( 1 - {p}_{a} ) ρ )\end{matrix} \\ where : \\ ρ = f ( M , [ \frac{MD}{{D}_{tot}} ] \hat{} M ) \\ {ρ}_{0} = f ( k , [ \frac{kD}{{D}_{tot}} ] \hat{} k ) ( 1 - \frac{1}{k} ) + \frac{1}{k} \\ {ρ}_{1} = f ( M - k , [ \frac{( M - k ) D}{{D}_{tot}} ] \hat{} ( M - k ) ) ( 1 - \frac{1}{M - k} ) + \frac{1}{M - k}\end{matrix}$$

with [x] being the floor of x and f defined as:

$$f ( n , k ) = \begin{matrix}\frac{2}{n ( n - 1 )} ( nk - ( 1 + \frac{{D}_{tot}}{D} ) \frac{k ( k + 1 )}{2} + \\ \frac{{D}_{tot}}{MD} \frac{k ( k + 1 ) ( 2 k + 1 )}{6} ) .\end{matrix}$$

Therefore the price, stated in the pricing grid as corresponding to k successes observed ex post, will be equal to the central price of the reference scenario, mentioned in [00115], plus the difference of the utility with the number of successes equal to k (computed with the expression in [00119]) and the utility with the number of successes equal to p_{α}M (also computed with the expression in [00119]).

Once the results of the tenders are known, the first adjustment to make is to adjust the price for the reference scenario according to the method exposed in [00117]-[00120]. The actual number of successes will be defined in order to take into account the relative sizes of the different tenders:

$${k}_{0} = \frac{{\sum }_{j = 1}^{M} {Σ}_{j} {Z}_{j}}{{\sum }_{j = 1}^{M} {Σ}_{j}} M$$

where Zⱼ is the outcome (0 or 1) of the tender j. The new price, or ‘adjusted’ price, of the reference scenario will be equal to the linear interpolation of those prices that have been defined in the grid for [k₀] and [k₀]+1 and that have been computed as described in [00117]-[00120] (remember that k₀ is not always an integer).

This adjusted reference price corresponds to the price of the option hedging a tender with the same characteristics as the reference scenario. As the client can include tenders that are different from the reference scenario, the price the client will have to pay for each tender that has been successful is going to be equal to the adjusted reference price times a so-called ‘size-adjustment.’

Using once again a mean-variance pricing approach (which corresponds to an order 2 Taylor approximation as in [0019]), one can show that the ratio of variance between the actual tenders and the reference scenario is equal to the ratio of sizes between the actual tenders and the reference scenario (sizes being defined as in [00112] and [00114]). Consequently, the ‘size-adjustment’ factor is:

$$A = \sqrt{{\sum }_{j = 1}^{M} \frac{{Σ}_{j}}{Σ}} .$$

As a conclusion, if there have been a number M_{success} of successful tenders, the client will pay at the end: M_{success} times A times the adjusted reference price computed as in [00121].

Therefore, with the adjustment factor in place, the financial institution is protected from market vagaries while the client is fully incentivized to provide accurate estimates of its probability of successful tender.

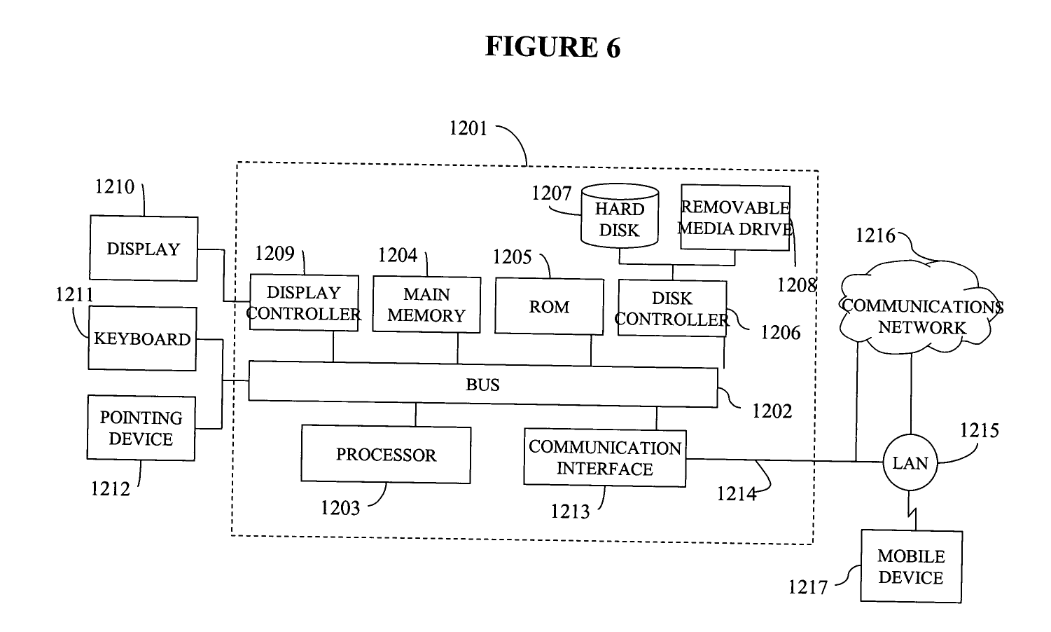

FIG. 6 illustrates an example basic computer block diagram used in association with this invention. The computer system 1201 includes a bus 1202 or other communication mechanism for communicating information, and a processor 1203 coupled with the bus 1202 for processing the information. The computer system 1201 also includes a main memory 1204, such as a random access memory (RAM) or other dynamic storage device (e.g., dynamic RAM (DRAM), static RAM (SRAM), and synchronous DRAM (SDRAM)), coupled to the bus 1202 for storing information and instructions to be executed by processor 1203. In addition, the main memory 1204 may be used for storing temporary variables or other intermediate information during the execution of instructions by the processor 1203. The computer system 1201 further includes a read only memory (ROM) 1205 or other static storage device (e.g., programmable ROM (PROM), erasable PROM (EPROM), and electrically erasable PROM (EEPROM)) coupled to the bus 1202 for storing static information and instructions for the processor 1203.

The computer system 1201 also includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1201 may also include a display controller 1209 coupled to the bus 1202 to control a display 1210, such as a cathode ray tube (CRT), for displaying information to a computer user. The computer system includes input devices, such as a keyboard 1211 and a pointing device 1212, for interacting with a computer user and providing information to the processor 1203. The pointing device 1212, for example, may be a mouse, a trackball, or a pointing stick for communicating direction information and command selections to the processor 1203 and for controlling cursor movement on the display 1210. In addition, a printer may provide printed listings of data stored and/or generated by the computer system 1201.

The computer system 1201 performs a portion or all of the processing steps of the invention in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1201, for driving a device or devices for implementing the invention, and for enabling the computer system 1201 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 1203 for execution. A computer readable medium may take many forms, including but not limited to, non-volatile media, volatile media, and transmission media. Non-volatile media includes, for example, optical, magnetic disks, and magneto-optical disks, such as the hard disk 1207 or the removable media drive 1208. Volatile media includes dynamic memory, such as the main memory 1204. Transmission media includes coaxial cables, copper wire and fiber optics, including the wires that make up the bus 1202. Transmission media also may also take the form of acoustic or light waves, such as those generated during radio wave and infrared data communications.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1201 may receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc). The signals through the various networks and the signals on the network link 1214 and through the communication interface 1213, which carry the digital data to and from the computer system 1201 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214, and the communication interface 1213. Moreover, the network link 1214 may provide a connection through a LAN 1215 to a mobile device 1217 such as a personal digital assistant (PDA) laptop computer, or cellular telephone.

The present invention includes a user-friendly interface that allows individuals of varying skill levels to search numerous digital media archives and archive types as well as allows users to design produce and print statistical reports about information stored within these archives. The interface allows users to optionally enable virus checking and duplicate checking as well as to determine and display the file types number of files and estimate number printed pages of printable files. The interface also allows individuals to easily identify and tag duplicates, infected files, and encoded and encrypted files. The interface also allows individuals to create a time stamp for digital authentication for each file processed. The present invention allows for such files to be sent to another device for further processing.

The present invention also includes software and computer programs designed to enable hedge portfolio management and risk reduction as described previously.

Numerous modifications and variations of the present invention are possible in light of the above teachings. It is therefore to be understood that, within the scope of the appended claims, the invention may be practiced otherwise than specifically described herein.

1. A method of hedging a financial risk of a commercial hazard, comprising:
grouping the financial risk with other financial risks;
determining a risk hedging parameter corresponding to the financial risk and the other financial risks;
defining an average risk reference scenario for the financial risk and the other financial risks;
determining a probability of occurrence for the commercial hazard and the other commercial hazards;
establishing a reference pricing grid expressing a risk hedging price for at least one of the financial risk and the other financial risks defined in the average risk reference scenario as a function of the actual outcomes of the respective commercial hazard and the other commercial hazards; and
adjusting the risk hedging price based on an actual occurrence of the respective commercial hazard and the other commercial hazards.

2. The method of claim 1, wherein the financial risk comprises at least one of:
a foreign exchange rate risk;
an interest rate risk;
a credit event risk; and
a utilities price risk.

3. The method of claim 1, wherein the at least one commercial hazard comprises:
at least one tender.

4. The method of claim 1, wherein the risk hedging parameter comprises:
a commitment on a number Nc of commercial hazards covered by a contract.

5. The method of claim 1, wherein the average risk reference scenario comprises:
an average risk associated with each of a number Nc of commercial hazards.

6. The method of claim 1, wherein the step of establishing a pricing grid, comprises:
establishing a pricing grid via at least one of
a statistics based process,
a probability theory based process, and
a game theory based process.

7. The method of claim 1, wherein the step of establishing a pricing grid comprises:
expressing the risk hedging priceas a function of an actual outcome of the respective commercial hazard and the other commercial hazards.

8. The method of claim 1, further comprising:
defining an adjustment rule for each hedging price of a risk in the reference pricing grid.

9. The method of claim 8, wherein the step of defining an adjustment rule comprises:
defining the adjustment rule as a function of a difference between a probability of occurrence of an outcome of one of the commercial hazard and the other commercial hazards and a corresponding actual outcome of the one of the commercial hazard and the other commercial hazards.

10. The method of claim 1, further comprising:
defining a rule for observing an actual outcome of one of the commercial hazard and the other commercial hazards.

11. A data processing system comprising:
an input mechanism configured to group a financial risk with other financial risks;
a calculating mechanism configured to determine a risk hedging parameter corresponding to the financial risk and the other financial risks;
a scenario building mechanism configured to define an average risk reference scenario for the financial risk and the other financial risks;
a calculating mechanism configured to calculate a probability of occurrence for the commercial hazard and the other commercial hazards;
a memory device configured to store a reference pricing grid expressing a risk hedging price for the financial risk and the other financial risks as a function of the actual outcomes of the respective commercial hazard and other commercial hazards; and
an adjustment mechanism configured to adjust the risk hedging price in the pricing grid based on an actual occurrence of the respective commercial hazard and the other commercial hazards.

12. The system of claim 11, wherein calculating mechanism comprises:
at least one of a statistics calculator, a probability theory calculator, and a game theory calculator.

13. The system of claim 11, wherein said memory device comprises:
a memory device configured to store the risk hedging price as a function of an actual outcome of the respective commercial hazard and the other commercial hazards.

14. The system of claim 11, further comprising:
an adjustment mechanism configured to define an adjustment rule for the risk hedging price.

15. The system of claim 14, wherein the adjustment mechanism comprises:
an adjustment mechanism configured to define the adjustment rule as a function of a difference between a probability of occurrence of an outcome of one of the commercial hazard and the other commercial hazards and a corresponding actual outcome of the one of the commercial hazard and the other commercial hazards.

16. The system of claim 11, further comprising:
a rule definition mechanism configured to define a rule for observing an actual outcome of one of the commercial hazard and the other commercial hazards.

17. A computer program product configured to host instructions to enable a data processing system to implement the method as claimed in claims 1-10.

18. A system for hedging at least one financial risk of at least one commercial hazard, comprising:
means for grouping the financial risk with other financial risks;
means for determining a risk hedging parameter corresponding to the financial risk and the other financial risks;
means for defining an average risk reference scenario for the financial risk and the other financial risks;
means for determining a probability of occurrence for the commercial hazard and the other commercial hazards;
means for establishing a reference pricing grid expressing a risk hedging price for at least one of the financial risk and the other financial risks defined in the average risk reference scenario as a function of the actual outcomes of the respective commercial hazard and the other commercial hazards; and
means for adjusting the risk hedging price based on an actual occurrence of the respective commercial hazard and the other commercial hazards.
